(19) United States
(12) Patent Application Publication
(10) Pub. No.: US 2007/0207085 A1
(43) Pub. Date: Sep. 6, 2007

(54) Power Systems Utilizing Hydrolytically Generated Hydrogen

(76) Inventor: Tomasz Troczynski, Vancouver (CA)

Correspondence Address: TODD N. HATHAWAY, 119 N. COMMERCIAL ST. #620, BELLINGHAM, WA, 98225, US

(21) Appl. No.: 10/593,767

(22) PCT Filed: Mar. 28, 2005
(86) PCT No.: PCT/US05/10283

§ 371 Date: Jan. 3, 2007

Related U.S. Application Data
(60) Provisional application No. 60/556,969, filed on Mar. 26, 2004.

(51) Int. Cl. C01B 3/08

(52) U.S. Cl. 423/657; 48/61

(57) ABSTRACT

An apparatus and method for generating hydrogen by hydrolytic reaction and supplying the hydrogen to a user device, such as a fuel cell. Water is selectively supplied to a reactor vessel containing supply of an aluminum composite reactive material to produce the hydrolytic reaction. Hydrogen from the reaction vessel is supplied to at least one metal hydride buffer vessel at a relatively high pressure, and is released from the buffer vessel to the user device at a relatively low pressure. In the case of fuel cells, the relatively low pressure is less than the maximum allowable supply pressure of the cell, obviating potential damage thereto. The hydrogen flow may be switched alternately between a plurality of buffer vessels, so that one vessel is being charged at the relatively higher pressure while the other is releasing hydrogen to the fuel cell at the relatively low pressure. Water may be supplied to the reactor vessel to produce the reaction in response to a demand for hydrogen from the fuel cell or other user device. The demand for hydrogen may be detected by sensing a pressure drop in the hydrogen flow to the user device. There may also be a plurality of reactor vessels, with the water supply being controllable on a separate basis so that hydrogen can be generated from the vessels in a sequential, staged or phased manner.

### RELATED APPLICATIONS

This application claims the benefit of U.S. Provisional Patent Application No. 60/556,969 filed on 26 Mar. 2004.

### BACKGROUND

a. Field of the Invention

The present invention relates generally to hydrogen-based power systems, and, more particularly, to a hydrogen production and supply system that generates hydrogen by hydrolysis using metal composite materials under near-neutral pH conditions in one or more reaction vessels, and that supplies the hydrogen to a fuel cell or other user device.

b. Related Art

Hydrogen-based fuel systems hold the promise of clean power from a renewable resource, i.e., water. In some instances, combustion of hydrogen in manner similar to that of fossil fuels (e.g., in a combustion engine) has been used or proposed, however, the efficiencies are comparatively low and a certain amount of environmentally undesirable emissions is inevitable; moreover, combustion-based systems are not suitable for use in many products, such as portable electrical and electronic devices. Fuel cells represent a more viable option for many applications, since they provide an electrical output with essentially no emissions and can be scaled to very large or very small sizes to meet the requirements of various applications. However, fuel cells are subject to comparatively narrow operating parameters, in particular are sensitive to supply pressures.

The most common methods of producing hydrogen have been electrolysis (i.e., passing electric current through water to disassociate the molecules) and extraction from fossil fuels such as natural gas or methanol. Where this is done at an industrial plant, the hydrogen can, of course, be compressed and stored in tanks or other containers. However, the barrier to successful use on a wide-spread basis lies primarily in problems of distribution, since transporting containers of compressed hydrogen is both expensive and dangerous. In many or most instances, therefore, it is preferable to generate the hydrogen locally (i.e., at or near the site of use) and on demand.

One approach, currently favored for vehicles, is to extract the hydrogen from a liquid hydrocarbon fuel (e.g., gasoline or methanol) that is carried in a non-pressurized tank. While perhaps less dangerous than transporting compressed hydrogen, the hazards and costs/complexity of hydrocarbon-fueled systems render them unsatisfactory for many applications, such as for use in portable electronic products. Such systems also produce environmentally undesirable emissions in the form of carbon dioxide, carbon monoxide and other gasses, and moreover many or most are reliant on fossil fuels derived from non-renewable sources.

Another way in which hydrogen may be generated on a localized or portable basis is by chemical reaction. As is well known, hydrogen is produced by chemical reaction between water and chemical hydrides, comprising hydrogen and one or more alkyl or alkyl earth metals; examples of metal hydrides that have been utilized in such processes include lithium hydride (LiH), lithium tetrahydridoalumimate (LiAlH₄), lithimun tetrahydridoborate (LiBH₄), sodium hydride (NaH), sodium tetrahydridoaluminate (NaAlH₄) and sodium tetrahydridoborate (NaBH₄). For example, lithium tetrahydridoaluminate reacts with water to produce hydrogen in the following equation:
LiAlH₄+2H₂O→LiAlO₂+4H₂

However, the reaction is highly exothermic (up to 700 kJ per mole) and potentially dangerous, so that the rate at which water is combined with the chemical hydride must precisely controlled in order to avoid a runaway reaction and possible explosion. Achieving such control has proven elusive. Most efforts have focussed on the use of catalysts, without which the hydrides will not react with water, and controlling the rate at which the reactants (water and hydride) are brought into contact with the catalyst surface. However, it has been found that when the reactions are controlled at levels that avoid runaway exothermic conditions they become unacceptably inefficient (for example, consuming only 40-60% of the available reactants), due in part to accumulation of reaction products on the catalyst.

Other attempts at controlling water-chemical hydride reactions have taken the approach of physically separating the reactants. For example, it has been proposed to maintain separation of the hydride from the water using a membrane that is permeable to water but impermeable to hydrogen and other reaction products. This is impractical due to the difficulty in producing a membrane that is permeable to water but not to hydrogen, since hydrogen molecules are significantly smaller than water molecules. The system that is shown in U.S. Pat. No. 5,702,491, in turn, attempts to improve control of the reaction by pre-heating the hydride prior to introducing water. This is intended to avoid the initial surge in pressure that is characteristic of chemical hydride systems, but it does nothing to help control the reaction after start-up. Moreover, the reliance on pre-heating decreases efficiency of the system and adds undesirable complication.

U.S. Pat. No. 5,702,491 also illustrates a rechargeable metal-hydride buffer, which is connected between the generator and a fuel cell to augment the flow of hydrogen during start-up and at other times when demand exceeds the rate of generation. The buffer is of little benefit, however, since the pressure that is required to effectively charge the metal hydride (typically, 10 atm) is some 3-4 times greater than the maximum pressure permitted for the fuel cell (typically, 1-3 atm or less). Consequently, operating the system at pressures high enough to charge the buffer would damage the fuel cell (e.g., cause rupture of the PEM membrane), while pressures low enough for the fuel cell would be inadequate to charge the buffer.

Yet other approaches have been proposed, but none has provided a satisfactory solution. Moreover, the cost of chemical hydrides is uneconomically high. Chemical hydride-water reactors have therefore remained largely unacceptable for use in association with fuel cells and other devices that require a supply of hydrogen within controlled parameters.

Hydrogen can also be produced by the simple reaction of water with alkaline metals, such as potassium or sodium. For example, the following reaction proceeds spontaneously:
2K+2H₂→2KOH+H₂

However, these reactions are not just exothermic but in fact violent, making them if anything more difficult to control than the water-metal hydride processes described above. Also, the residual hydroxide product (i.e., KOH is the above reaction) is highly alkaline, corrosive and dangerous to handle, and is hazardous to the environment. However, attempts to use metals having more benign characteristics (e.g., aluminum) have in the past been stymied by the tendency of reaction products to deposit on the surface of the metal, blocking further access to the surface and bringing the reaction to a halt in a phenomenon known as “passivation”.

Accordingly, there exists a need for a method and apparatus for on-board, on-demand generation and supply of hydrogen for use by fuel cells and other H₂-driven user devices. Furthermore, there exists a need for such a system that is self-controlling and avoids the potential for runaway reactions or explosion while still achieving an acceptable level of efficiency. Still further, there exists a need for such method and apparatus that can be scaled for use with portable devices or non-portable installations, as desired. Still further, there exists a need for such a method and apparatus that is environmentally friendly and does not produce problematic waste products. Still further, there exists a need for such a method and apparatus that is low cost and that can be implemented utilizing inexpensive, readily available materials.

### SUMMARY OF THE INVENTION

The present invention has solved the problems cited above, and is a system for generating hydrogen by hydrolytic reaction using a metal composite reactant material under near-neutral pH conditions, and for supplying the hydrogen to a fuel cell or other user device. The metal composite reactant material may be a mechanical amalgam of metallic aluminum and calcined alumina, compressed to pellet form.

Broadly, the system comprises a reactor vessel holding a supply of the aluminum composite reactant material, means for selectively supplying water to the reactor vessel so as to produce the hydrolysis reaction therein, means for capturing hydrogen generated by the hydrolysis reaction, and means for conveying the captured hydrogen to the fuel cell or other user device. The system may include buffer storage for receiving the hydrogen from the reactor vessel at a first, relatively high pressure, and then discharging the hydrogen to the fuel cell or other user device at a second, relatively low pressure.

The buffer storage may comprise first and second buffers, and means for switching flow of the hydrogen between the buffer vessels on an alternating basis, so that one buffer will be charging from the flow while the other is discharging to the fuel cell or other device. The buffer may comprise a receptacle containing a metal hydride material.

The means for selectively supplying water to the reactor vessel may comprise a water line connecting the reactor vessel to a source of water, a valve mounted in the water line for controlling flow of water therethrough, and control means for selectively opening the valve in response to a demand for hydrogen by the fuel cell or other user device. The control means may comprise a pressure sensor that senses pressure of the hydrogen in the flow to the fuel cell or other user device, and means for opening the valve in the water supply line in response to a sensed drop in the hydrogen pressure. The means for opening the valve may comprise an electronic processor that receives an output signal from the pressure sensor. The processor may also control the valve or valves for switching the flow of hydrogen between the first and second buffers.

In a preferred embodiment, the system may comprise a plurality of the reactor vessels, and means for separately controlling the supply of water to the vessels, so that hydrolysis can be produced in the different reactor vessels in a sequential, staged or phased manner.

The present invention also provides a method of supplying hydrogen to a user device. In a preferred embodiment, there is a method of supplying hydrogen to a fuel cell having a predetermined maximum allowable supply pressure, comprising the steps of: (a) selectively supplying water to an aluminum composite reactive material in at least one reactor vessel so as to produce a hydrolytic reaction that generates hydrogen; (b) supplying the hydrogen from the reactor vessel to at least one buffer vessel at a first, relatively higher pressure; and (c) releasing the hydrogen from the buffer vessel to the fuel cell at a second, relatively lower pressure that is at or below the maximum allowable supply pressure of the fuel cell.

The method may further comprise the step of switching flow of the hydrogen between a plurality of the buffer storage vessels on an alternating basis, so that a first of the buffer vessels is receiving the hydrogen from the reactor vessel at the relatively higher pressure while a second of the buffer vessels is releasing the hydrogen to the fuel cell at the relatively lower pressure.

The step of selectively supplying water to the aluminum composite reactant material in the at least one reactor vessel may comprise selectively opening a valve in the water supply line to the reactor vessel in response to a demand for hydrogen by the fuel cell. The step of selectively opening the valve in the water supply line may comprise opening the valve in response to a drop in pressure sensed in the flow of the hydrogen to the fuel cell.

These and other features and advantages of the present invention will be more readily understood from a reading of the following detailed description with reference to the accompanying drawings.

### BRIEF DESCRIPTION OF THE DRAWINGS

FIGS. 1A and 1B are schematic diagrams of a hydrogen generation and supply system in accordance with a first embodiment of the present invention, showing the manner in which hydrogen is generated in a reaction cell and the resulting flow is switched alternately between first and second metal-hydride storage buffers for subsequent release to a fuel cell; and

FIG. 2 is a schematic diagram of a hydrogen generation and supply apparatus in accordance with a second embodiment of the present invention, showing the use of multiple reaction cells that are supplied with water separately in a sequential, staged or phased manner so as to increase the duration or amount of hydrogen production in accordance with the demands of the user device.

### DETAILED DESCRIPTION

a. Overview

The present invention provides a safe, low cost, environmentally friendly system for on-demand supply of substantially pure hydrogen (H₂) within parameters that meet the requirements of fuel cells and similar user devices, and that can also be used with direct H₂-driven devices such as catalytic combustion devices or internal combustion engines. The system can be scaled for use in portable devices such as mobile electronics and transportable equipment, or for stationary applications such as emergency and household power supplies in remote (e.g., off-grid, off-gas) locations.

The system of the present invention alleviates the problems of the prior art systems described above, and uses an aluminum-based water split reaction as disclosed in U.S. Pat. No. 6,582,676 (Chaklader), which is incorporated herein by reference. The Chaklader reaction represents a variant of the water-chemical hydride reactions, but using aluminum. Reaction temperatures are far lower, alleviating the possibility of a runaway reaction and therefore permitting the design of a self-controlling H₂ generation system that does not require a catalyst to control the reaction.

The Chaklader reaction employs a composite reactant material, in which metallic aluminum is mechanically alloyed with alumina or certain other materials (ceramic compounds containing aluminum ions; carbon; calcium carbonate; calcium hydroxide), and pressed into pellet form. The composite material effectively hydrolyzes water to hydrogen at neutral or near neutral pH ranges, without experiencing passivation. Other metals such as magnesium and zinc may be used, but aluminum is preferred.

In a preferred form, the composite material is a combination of metallic aluminum with calcined Boehmite. Boehmite is one of the common forms of bauxite and as such is inexpensive and readily available. Moreover, as a primary raw material in the manufacture of aluminum, Boehmite (or an equivalent bauxite) will ordinarily be available at the smelter where the aluminum itself is produced and therefore need not be obtained separately. As an additional advantage, aluminum smelters typically employ hydroelectric power, so that, in terms of energy consumption, production of the aluminum composite material utilizes a renewable energy resource and creates essentially no emissions. Moreover, the “waste product” of the Chaklader reaction Al(OH)₃ is not only environmentally benign (being essentially the same as naturally-occurring bauxite), but it is also readily recycled in the production of aluminum if desired.

The Chaklader reaction has the added advantage of being able to proceed at comparatively high pressures. However, a trade-off of the controlled character of the reaction is that a significant induction period (about 1-3 minutes, depending on temperature) is needed before H₂ production reaches full capacity. Moreover, once water has been added to the aluminum composite material the reaction will proceed to completion, i.e., until either the water or reactive metal has been consumed.

The present invention provides a system that accommodates these limitations while providing a steady, controlled flow of hydrogen to the fuel cell or other H₂-driven device. In particular, as will be described in greater detail below, the system includes a reactor vessel and preferably at least one buffer that charges from the reactor vessel at an elevated pressure (e.g., 10 atm) and then discharges at a reduced pressure (e.g., 1-3 atm); preferably the system includes two buffers, so that one can be charged while the other is discharging to the fuel cell other user device. The buffer provides an initial flow to the user device during start-up, and may also be used to provide a flow of H₂ for warming one or more of the reactants so as to accelerate the water split reaction and reduce the induction period. It will be understood that the 1-3 minute induction delay may be tolerable or acceptable for some user devices that do not require immediate power (e.g., heaters), but such systems may still need the buffer to supply an initial source of energy to start the water split reactor, especially in cold climates.

The system also preferably includes a valve or other control mechanism that is responsive to demand and that controls the flow of water to the reactor vessel or vessels. In this manner, the reaction will only be an initiated when there is demand from the user device; the flow of water is terminated if H₂ demand ceases, leaving the remainder of the aluminum composite material unreacted for subsequent use. Moreover, the anti-passivation qualities of the aluminum composite material ensure that the material will remain comparatively “fresh” and free from an accumulation of reaction products that would interfere restarting the system after a period of non-use.

Where the user device is a fuel cell or other device in which the consumed hydrogen is converted to water, the resultant water flow can be recycled for use in the reaction, forming a closed, self-contained system.

b. Systems

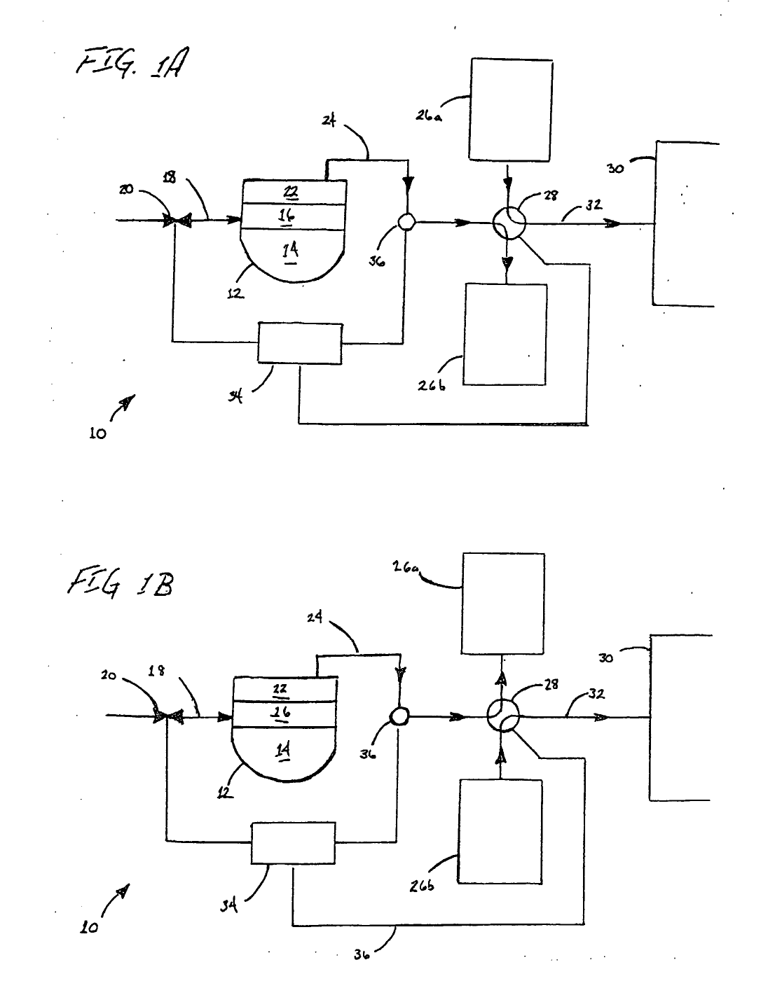

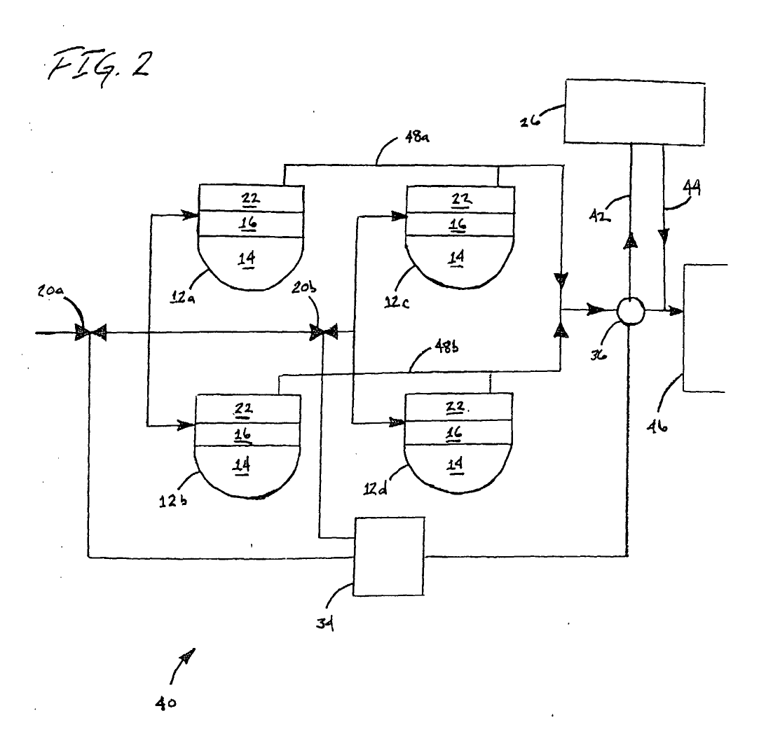

FIGS. 1A-1B and FIG. 2 show first and second systems in accordance with preferred embodiments of the present invention. Like reference numerals will refer to like elements throughout the drawings. It will be understood that features incorporated in one system may be used with the other, and vice versa.

FIGS. 1A-1B show a H₂ generation and supply system 10, having a reactor vessel or cell 12 in which the Chaklader reaction described above is carried out. As can be seen, the cell holds a volume of the aluminum composite material ready for use; in the illustrated embodiment, the reactor cell is pre-filled with the aluminum composite material for use on a batch-type basis; as the reactant material becomes depleted the reaction vessels can be refilled, or exchanged for fresh, pre-filled vessels. However, it will be understood that in some embodiments the material may be fed into the vessel in an ongoing manner to support a continuous reaction. It will also be understood that the figures represent schematic views of the systems, and that the actual configuration of the reactor vessel and other components will vary depending on design factors.

Water 16, in turn, is supplied to the reactor cell through a line 18 that is connected to a reservoir (not shown) or other source, with flow being controlled by a valve 20 or corresponding mechanism, as will be described in greater detail below. The type and size of the water supply or reservoir will vary with the size and nature of the system; for example, large systems for emergency power may be supplied from a large tank or pressurized (e.g., municipal) water system, whereas very small systems for portable electronic devices may be fed from a small water-saturated sponge by capillary action.

Following introduction of the water, hydrogen gas 22 is produced by the result reaction and is captured and fed from the cell via a discharge line 24. In the embodiment which is illustrated in FIGS. 1A-1B, which includes first and second H₂ storage buffers 26a, 26b, the discharge line 26 is connected to a diverter valve 28 that shifts the flow between the two buffers. The buffers are suitably receptacles or containers filled with metal hydride, which is capable of storing approximately 1-2 weight-percent H₂; metal hydride (e.g., nickel metal hydride) materials are generally preferred because they are rechargeable over many cycles, although it will be understood that other suitable buffers may be employed.

The control valve 28 in the illustrated embodiment is suitably a simple solenoid-operated 4-way valve, but again it will be understood that any suitable valve arrangement may be used. As can be seen in FIGS. 1A-1B, the valve is alternately switched from a first position in which H₂ is discharged to the fuel cell 30 from the first buffer 26a (via line 32), to a second position in which the roles are reversed i.e., the second buffer discharges to the fuel cell while the first is charging. In this manner, H₂ pressure from the reactor cell (which, as noted above, is sufficiently high to effectively charge the metal hydride material) is supplied only to the buffer that is being charged; the fuel cell receives only the low-pressure H₂ that is discharged from the buffers, and is kept isolated from the high pressures from the supply side and therefore protected from damage.

Switching of the diverter valve 28 is controlled by processor 34 (e.g., a process logic board). The processor receives input from a pressure sensor 36 (e.g., a pressure sensor transducer) that is mounted in the hydrogen discharge line 24 upstream of the diverter valve. As filling of the metal hydride buffer reaches capacity, an increase in pressure detected by sensor 36 may be used to actuate valve 28 to divert the flow to the other buffer; alternatively, the valve may be switched by the processor on the basis of elapsed time or another predetermined factor or routine.

Processor 34 also controls operation of the water supply valve 20. The valve may be opened in response to a signal received from the pressure sensor 36, for example, a signal resulting from a pressure drop that indicates demand from the fuel cell or other user device. Water will therefore be supplied only when there is demand for the H₂ produced by the hydrolytic reaction. In some embodiments the valve may also open in response to signals from other sensors, or in response to a manually or automatically actuated “on” switch.

Furthermore, in some embodiments the reaction may be controlled by means of the pressure build-up acting directly on the vessel rather than through the mechanism of the water control valve. Although the Chaklader reaction is capable of proceeding at relatively elevated pressures, it has been found that the reaction will not continue above a certain pressure. Control may therefore be achieved by regulating hydrogen flow in accordance with demand, so that with increased demand the pressure will be sufficiently low for the reaction to proceed and with reduced demand the pressure will increase and slow the reaction or bring it to a halt.

FIG. 2 shows a second system 40 that uses a plurality of reactor cells 12a-d rather than the single reactor cell that is shown in FIGS. 1A-1B. In addition, the system that is shown in FIG. 2 includes only a single hydrogen buffer 26, with supply and discharge lines 42, 44, rather than dual buffers; this may be acceptable in certain instances where, as noted above, the H₂ consuming device 46 does not require a buffer or is not sensitive to supply pressures. However, it will be understood that the system that is shown in FIG. 2 may also be used with fuel cells and may include dual buffers as well.

The multiple reaction cell configuration allows the cells to be actuated in a sequential or phased manner, as necessary or desirable for certain user devices. In the system 40 that is shown in FIG. 2, the cells are “ganged” in pairs—12a, 12b and 12c, 12d,—each with a separate water control valve 20a, 20b, the discharge sides of the reactor vessels turn being joined together by hydrogen collector lines 48a, 48b. The second pair of cells 12c, 12d may therefore be utilized to provide a reserve or surge capacity for the first pair 12a, 12b.

For example, the system may operate at a first, relatively low output, with only the single valve 20a open so that the hydrolytic reaction takes place only in the first pair of cells 12a, 12b. Then, in response to increased demand from the user device 46, detected as a pressure drop by sensor 36, the processor 34 will open the second valve 20b so as to commence hydrogen production in the second pair cells 12c, 12d and increase the total output of the system. Likewise, the processor 34 may close the second valve 20b in response to a reduced demand from the device 46, or may close both valves 20a, 20b if demand ceases altogether.

As another example, the pairs of cells may be actuated in a sequential manner, i.e., water may be supplied to the first pair of cells until the aluminum composite material has been fully consumed, at which time the second valve 20b is opened to begin hydrogen production in the second pair of cells 12c, 12d. Hydrogen production is thus continued for an extended period, the rate of output itself being unchanged.

It will be understood that a reserve capacity may be provided in some embodiments by simply increasing the size of the reactor vessel and then supplying water at a faster or slower rate as needed to meet the demand. However, the multiple configuration using smaller cells, as shown in FIG. 2, enjoys significant advantages in terms of efficiency and faster response times, and also avoids the need for a complex metering system.

The foregoing description of the preferred embodiment of the invention has been presented for the purpose of illustration and description. It is not intended to be exhaustive or to limit the invention to the precise form disclosed. Many modifications and variations are possible in light of the above teaching.

1. An apparatus for generating hydrogen by hydrolytic reaction and for supplying said hydrogen to a user device, said apparatus comprising:
at least one reactor vessel containing a supply of a metal composite reactant material;
means for selectively supplying water to said metal composite reactant material in said reactor vessel so as to produce said hydrolytic reaction therein; and
buffer storage that receives said hydrogen from said reactor vessel at a first, relatively higher pressure, and that releases said hydrogen to said user device at a second, relatively lower pressure;
said hydrogen being supplied to said user device via said buffer storage so that said user device receives said hydrogen at said second, relatively lower pressure and not at said first, relatively higher pressure.

2. The apparatus of claim 1, wherein said user device is a fuel cell having a predetermined maximum allowable supply pressure, and wherein said buffer storage is configured to release said hydrogen to said fuel cell at a pressure at or below said predetermined maximum allowable supply pressure.

3. The apparatus of claim 1, wherein said metal composite material in said reactor vessel comprises:
a mechanical amalgam of metallic aluminum and calcined alumina compressed to pellet form, that enables said hydrolytic reaction to proceed under near-neutral pH conditions.

4. The apparatus of claim 1, wherein said buffer storage comprises:
a plurality of buffer vessels; and
means for switching flow of said hydrogen between said buffer vessels on an alternating basis so that a first said buffer vessel is receiving said hydrogen from said reactor vessel while a second said buffer vessel is releasing said hydrogen to said user device.

5. The apparatus of claim 4, wherein each of said buffer vessels comprises:
a vessel holding a supply of metal hydride material.

6. The apparatus of claim 1, wherein said means for selectively supplying water to said metal composite reactant material in said reactor vessel comprises:
a water line connecting said reactor vessel to a supply of water;
a valve mounted in said water line for controlling flow of water to said reactor vessel therethrough; and
control means for selectively opening said valve in response to a demand for hydrogen by said user device.

7. The apparatus of claim 6, wherein said control means comprises:
a pressure sensor that senses pressure of said hydrogen in a flow thereof to said user device; and
means for opening said valve in response to a predetermined drop in pressure detected by said pressure sensor.

8. The apparatus of claim 7, wherein said means for opening said valve comprises:
an electronic processor that receives an output signal from said pressure sensor.

9. The apparatus of claim 1, further comprising:
a plurality of said reactor vessels, each reactor vessel holding a supply of said metal composite material.

10. (canceled)

11. An apparatus for generating hydrogen by hydrolytic reaction and for supplying said hydrogen to a fuel cell having a predetermined maximum allowable supply pressure, said apparatus comprising:
at least one reactor vessel holding a supply of an aluminum composite reactant material;
means for selectively supplying water to said aluminum composite reactant material in said reactor vessel so as to produce said hydrolytic reaction therein;
a plurality of buffer vessels that receive said hydrogen from said at least one reactor vessel at a first, relatively higher pressure and that release said hydrogen to said fuel cell at a second, relatively lower pressure at or below said maximum allowable supply pressure of said fuel cell, each of said buffer vessels holding a supply of metal hydride material for absorbing and releasing said hydrogen; and
means for switching flow of said hydrogen between said buffer vessels on an alternating basis so that a first said buffer vessel is receiving said hydrogen from said at least one reactor vessel while a second said buffer vessel is releasing said hydrogen to said fuel cell.

12. The apparatus of claim 11, wherein said means for selectively supplying water to said aluminum composite reactant material in said at least one reactor vessel comprises:
a water line connecting said reactor vessel to a supply of water;
a valve mounted in said water line for controlling flow of water to said reactor vessel therethrough; and
control means for selectively opening said valve in response to a demand for hydrogen by said fuel cell.

13. The apparatus of claim 12, wherein said control means comprises:
a pressure sensor that senses pressure of said hydrogen in a flow thereof to said fuel cell; and
means for opening said valve in response to a predetermined drop in pressure detected by said pressure sensor.

14. The apparatus of claim 12, wherein said at least one reactor vessel comprises:
a plurality of said reactor vessels, each holding a supply of said aluminum composite reactant material.

15. The apparatus of claim 14, wherein said means for selectively supplying water to said aluminum composite reactant material in said reactor vessels comprises:
means for controlling supply of water to each of said plurality of reactor vessels on a separate basis, so that said hydrolytic reaction can be selectively produced in said reactor vessels in a sequential, staged or phased manner.

16. A method for supplying hydrogen to a fuel cell having a predetermined maximum allowable supply pressure, said method comprising the steps of:
selectively supplying water to an aluminum composite reactant material in at least one reactor vessel so as to produce a hydrolytic reaction that generates hydrogen;
supplying said hydrogen from said reactor vessel to at least one buffer storage at a first, relatively higher pressure; and
releasing said hydrogen from said buffer storage to said fuel cell at a second, relatively lower pressure that is at or below said maximum allowable supply pressure of said fuel cell.

17. The method of claim 16, further comprising the step of:
providing said at least one reactor vessel with an aluminum composite material that comprises a mechanical amalgam of metallic aluminum and calcined alumina compressed to pellet form, that enables said hydrolytic reaction to proceed under near neutral pH conditions.

18. The method of claim 17, further comprising the step of:
switching flow of said hydrogen between a plurality of said buffer storage vessels on an alternating basis so that a first said buffer vessel is receiving said hydrogen from said reactor vessel at said relatively higher pressure while a second said buffer vessel is releasing said hydrogen to said fuel cell at said relatively lower pressure.

19. The method of claim 18, wherein the step of selectively supplying water to said aluminum composite reactant material in said at least one reactor vessel comprises:
selectively opening a valve in a water supply line to said reactor vessel in response to a demand for hydrogen by said fuel cell.

20. The method of claim 19, wherein the step of selectively opening a valve in said water supply line comprises:
opening said valve in response to a drop of pressure sensed in a flow of said hydrogen to said fuel cell.

21. An apparatus for generating hydrogen by hydrolytic reaction and for supplying said hydrogen to a user device, said apparatus comprising:
a plurality of reactor vessels, each reactor vessel containing a supply of a metal composite reactant material:
means for selectively supplying water to said metal composite reactant material in said reactor vessel so as to produce said hydrolytic reaction therein, said means for selectively supplying water to said metal composite reactant material comprising means for controlling supply of water to each of said plurality of reactor vessels on a separate basis, so that said hydrolytic reaction can be selectively produced in said reactor vessels in a sequential, staged or phased manner; and
buffer storage that receives said hydrogen from said reactor vessels at a first, relatively higher pressure, and that releases said hydrogen to said user device at a second, relatively lower pressure.
